(19) United States
(12) Patent Application Publication
(10) Pub. No.: US 2017/0369337 A1
(43) Pub. Date: Dec. 28, 2017

(54) ENHANCED BRINE CONCENTRATION WITH OSMOTICALLY DRIVEN MEMBRANE SYSTEMS AND PROCESSES

(71) Applicant: OASYS WATER, INC., Cambridge, MA (US)

(72) Inventors: Zachary W. Goodman, Rochester, MA (US); Leah Staschke, Boston, MA (US); MaryTheresa Pendergast, Braintree, MA (US)

(21) Appl. No.: 15/538,022

(22) PCT Filed: Dec. 16, 2015
(86) PCT No.: PCT/US15/66123

§ 371 Date: Jun. 20, 2017

Related U.S. Application Data
(60) Provisional application No. 62/096,104, filed on Dec. 23, 2014.
(60) Provisional application No. 62/121,913, filed on Feb. 27, 2015.
(60) Provisional application No. 62/142,199, filed on Apr. 2, 2015.

(51) Int. Cl. C02F 1/44; B01D 61/00; C02F 11/12; C02F 1/04; C02F 103/08; C02F 1/52

(52) U.S. Cl. CPC C02F 1/445; C02F 11/122; C02F 1/04; C02F 11/127; B01D 61/005; C02F 1/447; C02F 2001/5218; C02F 2103/08

(57) ABSTRACT

The invention generally relates to osmotically driven membrane systems and processes and more particularly to increased brine concentration for zero liquid discharge using osmotically driven membrane systems and processes and the related draw solute recovery techniques for the osmotically driven membrane systems and processes.

### FIELD OF THE TECHNOLOGY

Generally, the invention relates to osmotically driven membrane systems and processes and more particularly to increased brine concentration for zero liquid discharge (ZLD) using osmotically driven membrane systems and processes. The invention also relates to related draw solute recovery techniques for the osmotically driven membrane systems and processes.

### BACKGROUND

In general, osmotically driven membrane processes involve two solutions separated by a semi-permeable membrane. One solution may be, for example, seawater, while the other solution is a concentrated solution that generates a concentration gradient between the seawater and the concentrated solution. This gradient draws water from the seawater across the membrane, which selectively permits water to pass, but not salts, into the concentrated solution. Gradually, the water entering the concentrated solution dilutes the solution. The solutes then need to be removed from the dilute solution to generate potable water. Traditionally, the potable water was obtained, for example, via distillation; however, the solutes were typically not recovered and recycled.

In certain prior art systems that use distillation and low grade heat to recover draw solutes, it is necessary to perform condensation and absorption steps under vacuum in an attempt to maximize draw solute recovery. For example, a knock-out pot and an eductor (using air as a driving medium) are disposed downstream of the condensation and/or absorption processes in an attempt to improve draw solute recovery. However, this arrangement requires the venting of the non-condensable gases, which can also result in a loss of draw solutes and possible environmental issues. Additionally, the prior art systems for recovering draw solutes require considerable energy input (e.g., direct steam or electricity) that makes the recovery process inefficient and expensive.

Furthermore, many existing technologies for concentrating a feed stream are not capable of removing substantially all of the water, or other solvent, (i.e., ZLD) from the stream generally, and in particular without the use of complicated and/or very energy intensive equipment making it expensive and impractical to maximize the concentration of the feed stream to meet ZLD requirements.

### SUMMARY

The invention generally relates to systems and methods for increasing brine concentration to ZLD or near ZLD conditions and for recovering/recycling the draw solutions used in those systems and methods. The draw solutions are used in various osmotically driven membrane systems and methods, for example; forward osmosis (FO), pressure retarded osmosis (PRO), osmotic dilution (OD), direct osmotic concentration (DOC), or other processes that rely on the concentration (or variability thereof) of solutes in a solution. The systems and methods for draw solute recovery may be incorporated in various osmotically driven membrane systems/processes. Examples of osmotically driven membrane systems/processes are disclosed in U.S. Pat. Nos. 6,391,205, 7,560,029, and 9,039,899; U.S. Patent Publication Nos. 2011/0203994, 2012/0273417, and 2012/0267306; and PCT Publication No. WO2015/157031; the disclosures of which are hereby incorporated herein by reference in their entireties. In addition, a variety of draw solute recovery systems are disclosed in U.S. Pat. Nos. 8,246,791 and 9,044,711; the disclosures of which are also hereby incorporated herein by reference in their entireties.

Generally, the draw solution(s) used are aqueous solutions, i.e., the solvent is water; however, in some embodiments the draw solution is a non-aqueous solution using, for example, an organic solvent. The draw solution is intended to contain a higher concentration of solute relative to a feed or first solution so as to generate an osmotic pressure within the osmotically driven membrane system. The osmotic pressure may be used for a variety of purposes, including desalination, water treatment, solute concentration, power generation, and other applications. In some embodiments, the draw solution may include one or more removable solutes. In at least some embodiments, thermally removable (thermolytic) solutes may be used. For example, the draw solution may comprise a thermolytic salt solution, such as that disclosed in U.S. Pat. No. 7,560,029. Other possible thermolytic salts include various ionic species, such as chloride, sulfate, bromide, silicate, iodide, phosphate, sodium, magnesium, calcium, potassium, nitrate, arsenic, lithium, boron, strontium, molybdenum, manganese, aluminum, cadmium, chromium, cobalt, copper, iron, lead, nickel, selenium, silver, and zinc.

Generally, the feed or first solution may be any solution containing solvent and one or more solutes for which separation, concentration, purification, or other treatment is desired. In some embodiments, the first solution may be non-potable water such as seawater, salt water, brackish water, gray water, and some industrial water. In other embodiments, the first solution may be a process stream containing one or more solutes, such as target species, which it is desirable to concentrate, isolate, or recover. Such streams may be from an industrial process, such as a pharmaceutical or food grade application. Target species may include pharmaceuticals, salts, enzymes, proteins, catalysts, microorganisms, organic compounds, inorganic compounds, chemical precursors, chemical products, colloids, food products, or contaminants. The first solution may be delivered to a forward osmosis membrane treatment system from an upstream unit operation such as an industrial facility, or any other source, such as the ocean.

In one aspect, the invention relates to an osmotically driven membrane system and related process. Generally, the system includes one or more forward osmosis membrane modules including one or more membranes in each, a source of feed solution in fluid communication with one side of the one or more membranes, a source of concentrated draw solution in fluid communication with an opposite side of the one or more membranes, and a draw solution recovery system in fluid communication with the forward osmosis membrane module(s).

In another aspect, the invention relates to a system for concentrating a feed stream and recovering draw solution solutes from an osmotically driven membrane system. The system includes one or more forward osmosis modules, each having one or more membranes having first sides and second sides, the first side(s) of the membrane(s) fluidly coupled to a source of a first solution and the second side(s) of the membrane(s) fluidly coupled to a source of a concentrated draw solution, wherein the membrane(s) is configured for osmotically separating a solvent from the first solution, thereby forming a more concentrated first solution on the first side(s) of the membrane(s) and a dilute draw solution on the second side(s) of the membrane(s) and a separation system in fluid communication with the forward osmosis module(s) and configured for receiving the concentrated first solution and the dilute draw solution from the forward osmosis module(s). The separation system includes a first separation apparatus and a second separation apparatus. The first separation apparatus is in fluid communication with the osmotically driven membrane system and includes a first thermal recovery device, a first heat transfer means (e.g., a heat exchanger or other type of condenser) in fluid communication with the forward osmosis module(s) for receiving the dilute draw solution and coupled to a first inlet of the first thermal recovery device for preheating and introducing the dilute draw solution into the first thermal recovery device, a second heat transfer means coupled to the first thermal recovery device and having an inlet coupled to a first source of thermal energy and an outlet coupled to the first thermal recovery device for directing thermal energy to the first thermal recovery device to cause solutes within the dilute draw solution in the first thermal recovery device to vaporize, a first outlet for removing the vaporized dilute draw solution solutes from the first thermal recovery device, wherein the first outlet is in fluid communication with the first heat transfer means for providing the vaporized draw solution solutes as a source of thermal energy thereto for preheating the dilute draw solution (and partially condensing the vaporized draw solution into at least an intermediary concentrated draw solution), and a second outlet for removing a bottoms product from the first thermal recovery device.

The second separation apparatus is in fluid communication with the osmotically driven membrane system and includes a second thermal recovery device, a first heat transfer means in fluid communication with the forward osmosis module(s) for receiving the concentrated first solution and coupled to a first inlet of the second thermal recovery device for preheating and introducing the concentrated first solution into the second thermal recovery device, a second heat transfer means coupled to the second thermal recovery device and having an inlet coupled to a second source of thermal energy and an outlet coupled to the second thermal recovery device for directing thermal energy to the second thermal recovery device to cause solutes within the concentrated first solution in the second thermal recovery device to vaporize, a first outlet for removing the vaporized solutes from the second thermal recovery device, wherein the first outlet is in fluid communication with the first heat transfer means for providing the vaporized solutes as a source of thermal energy thereto for preheating the concentrated first solution, and a second outlet for removing a bottoms product from the second thermal recovery device.

In another aspect, the invention relates to a system for concentrating a feed stream and recovering draw solution solutes from an osmotically driven membrane system. The system includes one or more forward osmosis module(s), each comprising one or more membranes having first sides and second sides, the first side(s) of the membrane(s) fluidly coupled to a source of a first solution and the second side(s) of the membrane(s) fluidly coupled to a source of a concentrated draw solution, wherein the membrane(s) is configured for osmotically separating a solvent from the first solution, thereby forming a more concentrated first solution on the first side(s) of the membrane(s) and a dilute draw solution on the second side(s) of the membrane(s) and a separation system in fluid communication with the forward osmosis module(s) and configured for receiving the concentrated first solution and the dilute draw solution from the forward osmosis modules(s). The separation system includes a first separation apparatus and a second separation apparatus. The first separation apparatus is in fluid communication with the osmotically driven membrane system and includes a first thermal recovery device, a first heat transfer means in fluid communication with the forward osmosis module(s) for receiving the dilute draw solution and a first source of thermal energy for preheating the dilute draw solution, the first heat transfer means coupled to a first inlet of the first thermal recovery device for introducing the preheated dilute draw solution into the first thermal recovery device, a second heat transfer means coupled to the first thermal recovery device and having an inlet coupled to a second source of thermal energy and an outlet coupled to the first thermal recovery device for directing the second source of thermal energy to the first thermal recovery device to cause solutes within the dilute draw solution in the first thermal recovery device to vaporize, a first outlet for removing the vaporized dilute draw solution solutes from the first thermal recovery device, and a second outlet for removing a bottoms product from the first thermal recovery device, wherein the second outlet is in fluid communication with the first heat transfer means for providing the bottoms product as the first source of thermal energy thereto for preheating the dilute draw solution.

The second separation apparatus is in fluid communication with the osmotically driven membrane system and includes a second thermal recovery device, a heat transfer means in fluid communication with the forward osmosis module(s) for receiving the concentrated first solution and a source of thermal energy for heating the concentrated first solution, the heat transfer means coupled to a first inlet of the second thermal recovery device for introducing the heated concentrated first solution into the second thermal recovery device, where solutes within the concentrated first solution in the second thermal recovery device are vaporized, a first outlet for removing the vaporized solutes from the second thermal recovery device, and a second outlet for removing a concentrated brine from the second thermal recovery device.

In various embodiments of the foregoing aspects, the first and second thermal recovery devices can be distillation apparatus (e.g., column- or membrane-based). In some embodiments, the second thermal recovery device can be a crystallizer. In one or more embodiments, the systems can include one or more compressors in fluid communication with the first outlet of the first thermal recovery device and at least one of the heat transfer means of the first and/or second separation apparatus and/or one or more compressors in fluid communication with the first outlet of the second thermal recovery device and at least one of the heat transfer means of the first and/or second thermal recovery devices for providing at least a portion of the source of thermal energy thereto. Additionally, the systems can include at least one condenser having an inlet in fluid communication with at least one of the first outlet of the first thermal recovery device and/or the first outlet of the second thermal recovery device for receiving the bottoms product of the first and/or second thermal recovery device and an outlet in fluid communication with the forward osmosis module(s) for providing the concentrated draw solution thereto. The first and second separation apparatus can be configured for essentially parallel operation and the apparatus can themselves include one or more thermal recovery devices (e.g., distillation apparatus) configured in series, parallel, or combinations thereof.

In another aspect, the invention relates to a method of enhancing brine concentration and recovering draw solutes from an osmotically driven membrane system. The method can include the steps of providing a source of dilute draw solution from the osmotically driven membrane system, wherein the dilute draw solution comprises thermally removable draw solutes; providing a source of a concentrated feed solution from the osmotically driven membrane system, wherein the concentrated feed comprises a brine and thermally removable draw solutes that reverse fluxed through the membrane system; introducing at least a portion of the dilute draw solution to a first separation system; introducing a first source thermal energy to the first separation system; vaporizing dilute draw solution solutes out of the dilute draw solution; recovering the vaporized dilute draw solution solutes from the first separation system; recycling the draw solution solutes from the first separation system to the osmotically driven membrane system; introducing at least a portion of the concentrated feed solution to a second separation system; introducing a second source of thermal energy to the second separation system; vaporizing draw solutes and solvent out of the concentrated feed solution; recovering the vaporized draw solutes and solvent from the second separation system and discharging a further concentrated feed solution therefrom; and recycling the draw solutes and solvent from the second separation system to the osmotically driven membrane system.

In various embodiments, the method further includes directing the further concentrated feed solution to at least one of a filter press or a centrifuge. In addition, the further concentrated feed solution can be reintroduced from the at least one of a filter press or a centrifuge to the second separation apparatus. In some embodiments, the step of vaporizing the dilute draw solution solutes out of the first separation system can include exposing the dilute draw solution to the first source of thermal energy via a distillation apparatus and the step of vaporizing the draw solutes and solvent out of the second separation system can include exposing the concentrated feed solution to the second source of thermal energy via a crystallizer. In addition, the steps of recycling the dilute draw solution solutes from the first separation apparatus and recycling the draw solutes from the concentrated feed solution includes condensing the vapors prior to re-introduction of the solutes to the osmotically driven membrane system as a source of concentrated draw solution.

In another aspect, the invention relates to a system for concentrating a feed stream and recovering draw solution solutes from an osmotically driven membrane system. The system includes one or more forward osmosis modules, each having one or more membranes having first side(s) and second side(s), the first side(s) of the membrane(s) fluidly coupled to a source of a first solution and the second side(s) of the membrane(s) fluidly coupled to a source of a concentrated draw solution, wherein the membrane(s) is configured for osmotically separating a solvent from the first solution, thereby forming a more concentrated first solution on the first side(s) of the membrane(s) and a dilute draw solution on the second side(s) of the membrane(s), and a separation system in fluid communication with the forward osmosis module(s) and configured for receiving the concentrated first solution and the dilute draw solution from the forward osmosis module(s). The separation system includes a first separation apparatus in fluid communication with the osmotically driven membrane system and a second separation apparatus in fluid communication with the osmotically driven membrane system. The first separation apparatus includes a first thermal recovery device, a first heat transfer means in fluid communication with the forward osmosis unit and configured for receiving the dilute draw solution and coupled to a first inlet of the first thermal recovery device for preheating and introducing the dilute draw solution into the first thermal recovery device, a second heat transfer means coupled to the first thermal recovery device and having an inlet coupled to a first source of thermal energy and an outlet coupled to the first thermal recovery device for directing the first source of thermal energy to the first thermal recovery device to cause solutes within the dilute draw solution in the first thermal recovery device to vaporize, a first outlet for removing the vaporized draw solution solutes from the first thermal recovery device, and a second outlet for removing a heated bottoms product from the first thermal recovery device, wherein the second outlet is in fluid communication with the first heat transfer means for providing the heated bottoms product as a source of thermal energy thereto for preheating the dilute draw solution.

The second separation apparatus includes a second thermal recovery device, a first heat transfer means in fluid communication with the forward osmosis unit and configured for receiving the concentrated first solution and coupled to a first inlet of the second thermal recovery device for preheating and introducing the concentrated first solution into the second thermal recovery device, wherein the first outlet of the first separation apparatus is in fluid communication with the first heat transfer means of the second separation apparatus for providing the vaporized draw solution solutes as a source of thermal energy thereto for preheating the concentrated first solution, a second heat transfer means coupled to the second thermal recovery device and having an inlet coupled to a second source of thermal energy and an outlet coupled to the second thermal recovery device for directing the second source of thermal energy to the second thermal recovery device to cause solutes within the concentrated first solution in the second thermal recovery device to vaporize, a first outlet for removing the vaporized solutes from the second thermal recovery device, wherein the first outlet is in fluid communication with the first thermal recovery device for providing the vaporized solutes as an additional source of thermal energy thereto, and a second outlet for removing a bottoms product from the second thermal recovery device.

In various embodiments of the foregoing aspect, at least one of the first thermal recovery device or the second thermal recovery device can be a distillation apparatus, such as a distillation column or membrane distillation device. In some embodiments, the second thermal recovery device can be a crystallizer. Additionally, the system can further include at least one condenser having an inlet in fluid communication with at least one of the first outlet of the first thermal recovery device or the first outlet of the second thermal recovery device for receiving the tops product (i.e., vaporized draw solutes) of the first and/or second thermal recovery device (either directly or after exiting one of the heat transfer means) and an outlet in fluid communication with the forward osmosis module(s) for providing the concentrated draw solution thereto.

In another aspect, the invention relates to a system for concentrating a feed stream and recovering draw solution solutes from an osmotically driven membrane system. The system includes one or more forward osmosis modules, each having one or more membranes having first side(s) and second side(s), the first side(s) of the membrane(s) fluidly coupled to a source of a first solution and the second side(s) of the membrane(s) fluidly coupled to a source of a concentrated draw solution, wherein the membrane(s) is configured for osmotically separating a solvent from the first solution, thereby forming a more concentrated first solution on the first side(s) of the membrane(s) and a dilute draw solution on the second side(s) of the membrane(s), and a separation system in fluid communication with the forward osmosis module(s) and configured for receiving the concentrated first solution and the dilute draw solution from the forward osmosis module(s). The separation system includes a first separation apparatus in fluid communication with the osmotically driven membrane system for receiving the dilute draw solution and a second separation apparatus in fluid communication with the osmotically driven membrane system for receiving the concentrated first solution. The first separation apparatus includes a first thermal recovery device in fluid communication with the forward osmosis module(s) and configured for receiving the dilute draw solution, a first heat transfer means coupled to the first thermal recovery device and having an inlet coupled to a first source of thermal energy and an outlet coupled to the first thermal recovery device for directing the first source of thermal energy to the first thermal recovery device to cause solutes within the dilute draw solution in the first thermal recovery device to vaporize, a first outlet for removing the vaporized dilute draw solution solutes from the first thermal recovery device, a second outlet for removing a bottoms product from the first thermal recovery device, and a compressor in fluid communication with the first outlet of the thermal recovery device and the inlet of the first heat transfer means for providing at least a portion of the first source of thermal energy. The second separation apparatus includes a second thermal recovery device in fluid communication with the forward osmosis module(s) and configured for receiving the concentrated first solution, a heat transfer means coupled to a first inlet of the second thermal recovery device for introducing a second source of thermal energy to the second thermal recovery device to cause solutes within the second thermal recovery device to vaporize, a first outlet for removing the vaporized solutes from the second thermal recovery device and in fluid communication with an inlet on the first thermal recovery device to transfer the vaporized solutes thereto and provide an additional source of thermal energy to the first thermal recovery device, and a second outlet for removing a concentrated brine from the second thermal recovery device. In various embodiments, the second source of thermal energy is process or direct steam.

In another aspect, the invention relates to a method of enhancing brine concentration and recovering draw solutes from an osmotically driven membrane system, such as those previously described. The method includes the steps of providing a source of dilute draw solution from the osmotically driven membrane system, wherein the dilute draw solution comprises thermally removable draw solutes; providing a source of a concentrated feed solution from the osmotically driven membrane system, wherein the concentrated feed comprises a brine and thermally removable draw solutes that reverse fluxed through the membrane system; introducing at least a portion of the dilute draw solution to a first separation system; introducing a first source of thermal energy to the first separation system; vaporizing draw solution solutes out of the dilute draw solution; directing the vaporized draw solution solutes from the first separation system to a compressor; introducing the compressed vaporized draw solution solutes to the first separation system as at least a portion of the first source of thermal energy; introducing at least a portion of the concentrated feed solution to a second separation system; introducing a second source of thermal energy to the second separation system; vaporizing draw solutes and solvent out of the concentrated feed solution; directing the vaporized draw solutes and solvent from the second separation system to the first separation system to provide an additional source of thermal energy to the first separation system; and discharging a further concentrated feed solution from the second separation system.

In various embodiments of the foregoing aspect, the second source of thermal energy is process or direct steam. The method can also include the step of recycling the draw solution solutes from the first separation system to the osmotically driven membrane system. In various embodiments, the step of vaporizing the dilute draw solution solutes out of the first separation system can include exposing the dilute draw solution to the first source of thermal energy via a distillation apparatus, the step of vaporizing the draw solutes and solvent out of the second separation system can include exposing the concentrated feed solution to the second source of thermal energy via a distillation apparatus, and/or the step of vaporizing the draw solutes and solvent out of the second separation system can include exposing the concentrated feed solution to the second source of thermal energy via a crystallizer.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention and are not intended as a definition of the limits of the invention. For purposes of clarity, not every component may be labeled in every drawing. In the following description, various embodiments of the present invention are described with reference to the following drawings, in which:

FIG. 1 is a schematic representation of an exemplary osmotically driven membrane system/process using a solute recovery system in accordance with one or more embodiments of the invention;

FIG. 2 is a schematic representation of one embodiment of a draw solution recovery system in accordance with one or more embodiments of the invention;

FIGS. 3A-3D are a schematic representation of osmotically driven membrane systems and alternative draw solution recovery systems in accordance with one or more embodiments of the invention;

FIG. 4 is a schematic representation of an alternative osmotically driven membrane system for enhanced brine concentration and draw solute recovery in accordance with one or more embodiments of the invention;

FIG. 5 is a schematic representation of another alternative osmotically driven membrane system for enhanced brine concentration and draw solute recovery in accordance with one or more embodiments of the invention;

FIG. 6 is a schematic representation of yet another alternative osmotically driven membrane system for enhanced brine concentration and draw solute recovery in accordance with one or more embodiments of the invention; and

FIG. 7 is a schematic representation of an osmotically driven membrane system and another alternative system for enhanced draw solute recovery in accordance with one or more embodiments of the invention.

### DETAILED DESCRIPTION

Various embodiments of the invention may be used in any osmotically driven membrane process, such as FO, PRO, OD, DOC, etc. An osmotically driven membrane process for extracting a solvent from a solution generally involves exposing the solution to a first surface of a forward osmosis membrane. In some embodiments, the first solution (known as a process or feed solution) may be seawater, brackish water, wastewater, contaminated water, a process stream, or other aqueous solution. In at least one embodiment, the solvent is water; however, other embodiments may use non-aqueous solvents. A second solution (known as a draw solution) with an increased concentration of solute(s) relative to that of the first solution is exposed to a second, opposed surface of the forward osmosis membrane. Solvent, for example water, may then be drawn from the first solution through the forward osmosis membrane and into the second solution generating a solvent-enriched solution via forward osmosis. The solvent-enriched solution, also referred to as a dilute draw solution, may be collected at a first outlet and undergo a further separation process. In some embodiments, purified water may be produced as a product from the solvent-enriched solution. A second product stream, i.e., the depleted or concentrated first solution, may be collected at a second outlet for discharge or further treatment. The concentrated first solution may contain one or more target compounds that it may be desirable to concentrate or otherwise isolate for downstream use.

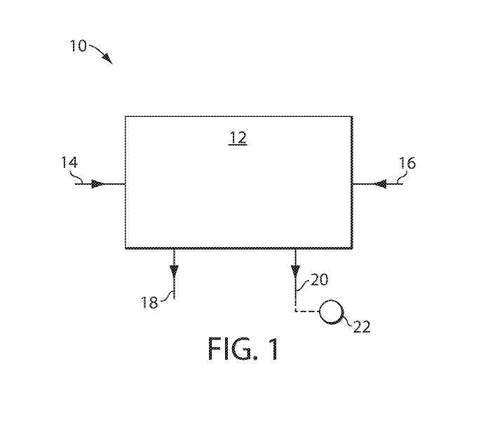

FIG. 1 depicts one exemplary osmotically driven membrane system/process 10 utilizing a draw solute recovery system 22 in accordance with one or more embodiments of the invention. As shown in FIG. 1, the system/process 10 includes a forward osmosis module 12, such as those incorporated by reference herein, in fluid communication with a feed solution source or stream 14 and a draw solution source or stream 16. The draw solution source 16 can include, for example, a saline stream, such as sea water, or another solution as described herein that can act as an osmotic agent to dewater the feed source 14 by osmosis through a forward osmosis membrane within the module 12. The module 12 outputs a stream of concentrated solution 18 from the feed stream 14 that can be further processed. The module 12 also outputs a dilute draw solution 20 that can be further processed via the recovery system 22, as described herein, where draw solutes and a target solvent can be recovered. In accordance with one or more embodiments of the invention, the draw solutes are recovered for reuse.

The forward osmosis membranes may generally be semi-permeable, for example, allowing the passage of a solvent such as water, but excluding dissolved solutes therein, such as those disclosed herein. Many types of semi-permeable membranes are suitable for this purpose provided that they are capable of allowing the passage of the solvent, while blocking the passage of the solutes and not reacting with the solutes in the solution. The membrane can have a variety of configurations, including thin films, hollow fiber, spiral wound, monofilaments, and disk tubes. There are numerous well-known, commercially available semi-permeable membranes that are characterized by having pores small enough to allow water to pass while screening out solute molecules, such as, for example, sodium chloride and their ionic molecular species such as chloride. Such semi-permeable membranes can be made of organic or inorganic materials, as long as the material selected is compatible with the particular draw solution used.

Generally, the material selected for use as the semi-permeable membrane should be able to withstand various process conditions to which the membrane may be subjected. For example, it may be desirable that the membrane be able to withstand elevated temperatures, such as those associated with sterilization or other high temperature processes. In some embodiments, a forward osmosis membrane module may be operated at a temperature in the range of about 0 degrees Celsius to about 100 degrees Celsius. In some embodiments, process temperatures may range from about 40 degrees Celsius to about 50 degrees Celsius. Likewise, it may be desirable for the membrane to be able to maintain integrity under various pH conditions. For example, one or more solutions in the membrane environment, such as the draw solution, may be more or less acidic or basic. In some embodiments, a forward osmosis membrane module may be operated at a pH level of between about 2 and about 11. In certain embodiments, the pH level may be about 7 to about 10. In at least one embodiment, the membrane may be an asymmetric membrane, such as with an active layer on a first surface, and a supporting layer on a second surface. One example of a suitable membrane is disclosed in U.S. Pat. No. 8,181,794, the disclosure of which is hereby incorporated herein by reference in its entirety.

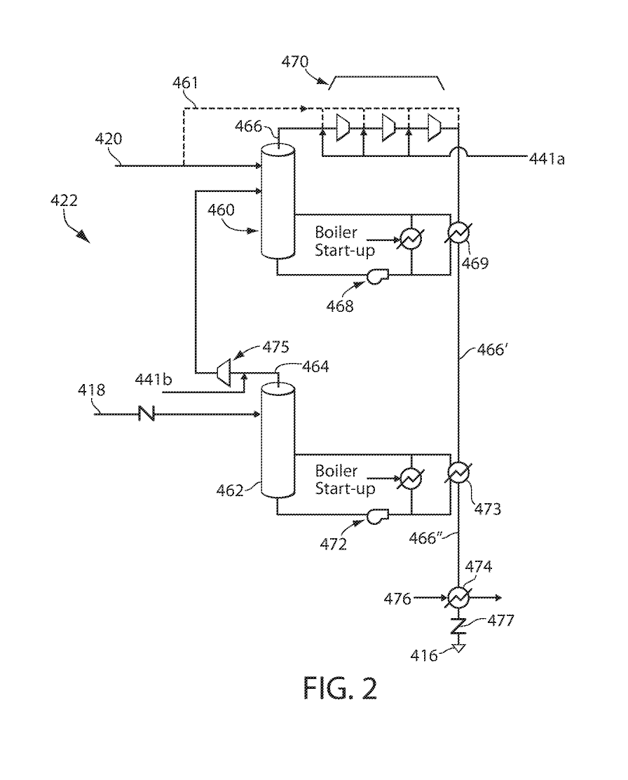

Generally, the various draw solutions discussed herein can be regenerated by recovering and recycling the draw solutes using various combinations of distillation apparatus, filters, condensers, crystallizers, compressors, and related components, as shown in FIGS. 2-7. FIG. 2 depicts one embodiment of a draw solute recovery/separation system 422 as can be part of, for example, a membrane brine concentrator. As shown, the system 422 incorporates two separation apparatus; the dilute draw solution (DDS) stripping column 460 and the concentrate or brine stripping column 462. The DDS column feed includes the dilute draw solution 420, which includes the water recovered from an osmotically driven membrane system. The DDS column 460 eventually outputs the product solvent. The concentrate column feed includes at least the concentrated brine 418 from the osmotically driven membrane system. These columns are in fluid communication with one or more compressors 470, 475. Mechanical vapor compression (MVC) is incorporated with the distillation columns to recover and re-use heat. Membrane distillation devices are also contemplated and considered within the scope of the invention.

The vapor 464 exiting the top of the concentrate column 462 is fed to the DDS column 460 in order to reduce the overall energy requirements of the DDS column 460. In some embodiments, the vapor 464 is first compressed (via compressor 475) to the pressure of the DDS column 460 so that the two columns 460, 462 can be operated at different pressures. In some embodiments, this vapor 464 includes additional draw solutes that may have reverse fluxed through the membrane of the osmotically driven membrane system and additional product solvent that did not pass through the membrane. The vapor 466 exiting the top of the DDS column 460 is compressed and exchanged with the DDS column reboiler 468. By compressing the DDS column vapor 466, the vapor condensing temperature is raised to a temperature that is higher than the DDS column reboiler 468 and, therefore, the latent heat of the vapor can be utilized as the supply heat to the column reboiler 468. Typically this vapor 466 will include the draw solutes in gaseous form. The pressure of the DDS column vapor 466 is controlled by a pressure control valve 477 and compressed to the appropriate pressure using a 3 stage rotary lobe blower system or a screw compressor 470. Different compressors/blowers and various numbers of stages may be used to suit a particular application. In one embodiment, with approximately 650 kW of blower input power, the system is able to transfer approximately 6,600 kW of thermal energy. In an alternative embodiment, the heat from each stage is transferred to the column reboiler.

Leaving the DDS column reboiler heat exchanger 469, the compressed partially condensed DDS column vapor 466′ is exchanged with the concentrate column reboiler 472. In this exemplary embodiment, the concentrate column 462 is run under a vacuum (approximately 0.1-0.9 atm absolute pressure) in order to reduce the boiling temperature of the reboiler loop water supplying steam to the column in order to exchange the remaining latent heat of the DDS column vapor 466′ with the concentrate column reboiler 472. Leaving the concentrate column reboiler heat exchanger 473, the mostly condensed DDS column vapor 466″ is fully condensed in a final condenser 474 utilizing cooling water 476, thereby forming the concentrated draw solution 416. Alternatively, the columns 460, 462 can be operated at the same or substantially equivalent pressures and the vapor stream 466 split and sent to each reboiler separately, typically without the use of a compressor. In this embodiment, the partially/mostly condensed DDS columns vapors 466′, 466″ exiting the reboilers 469, 473 can be combined and sent to the final condenser 474 to form the concentrated draw solution 416.

In some embodiments, for example where the vapor exiting the column contains essentially no liquid portion, there is nothing for the draw solutes (e.g., ammonia and carbon dioxide in gaseous form) to be compressed into. The solutes could transition from the gaseous phase directly to the solid phase (e.g., deposition or desublimation), which could potentially render the recovery system 422 inoperable. Where that may be the case, the system 422 can include a by-pass line 461 for directing a portion of the dilute draw solution 420 to the compression operation, thereby providing a liquid for absorbing the gaseous solutes. In some embodiments, the introduction of the dilute draw solution may expedite the absorption of CO₂ (e.g., as may be present when using a NH₃—CO₂ draw solution). As shown, the dilute draw solution 420 can be combined with the vapor 466 before or after any particular compressor to suit a particular application (e.g., a single compressor or series of compressors, the nature of the draw solutes, etc.). Additionally, the dilute draw solution 420, or other suitable liquid, can also be used to provide the liquid injection at the identified points 441a, 441b to reduce heat. The by-pass line 461 can include any number and combination of valves and sensors as necessary to suit a particular application.

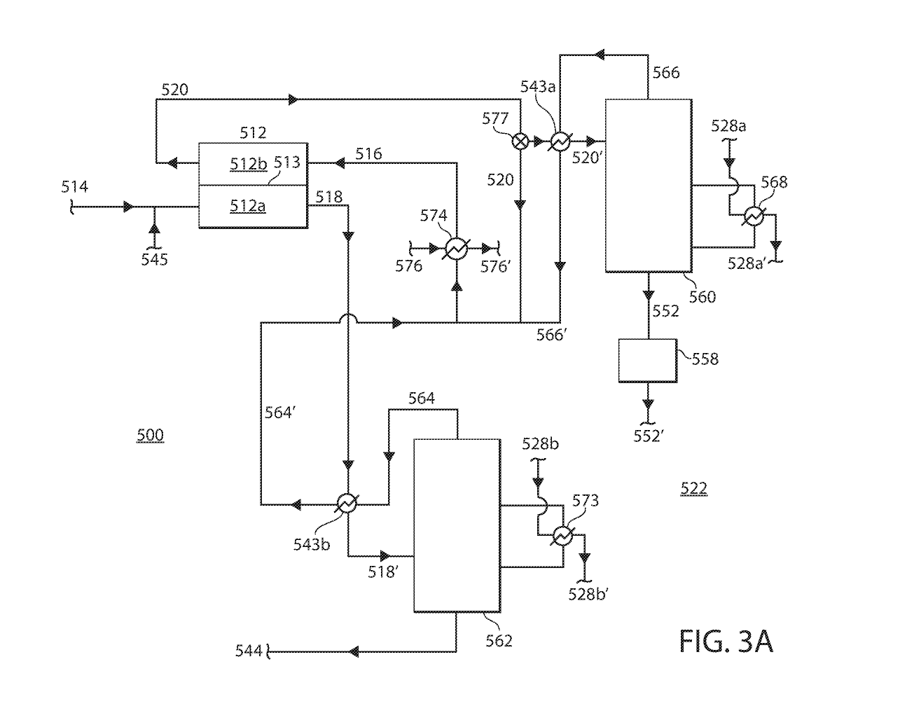

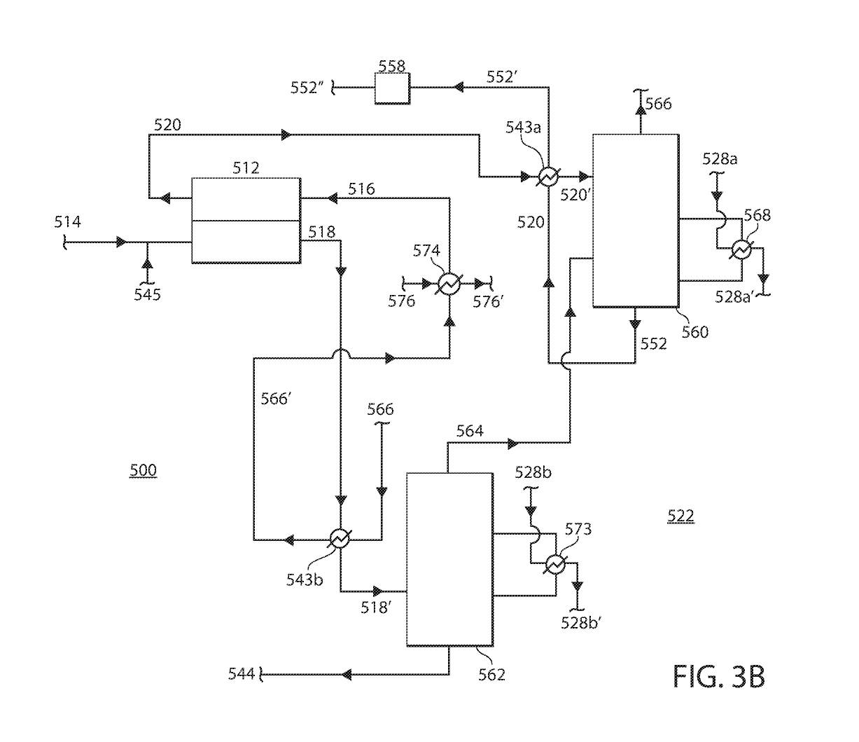

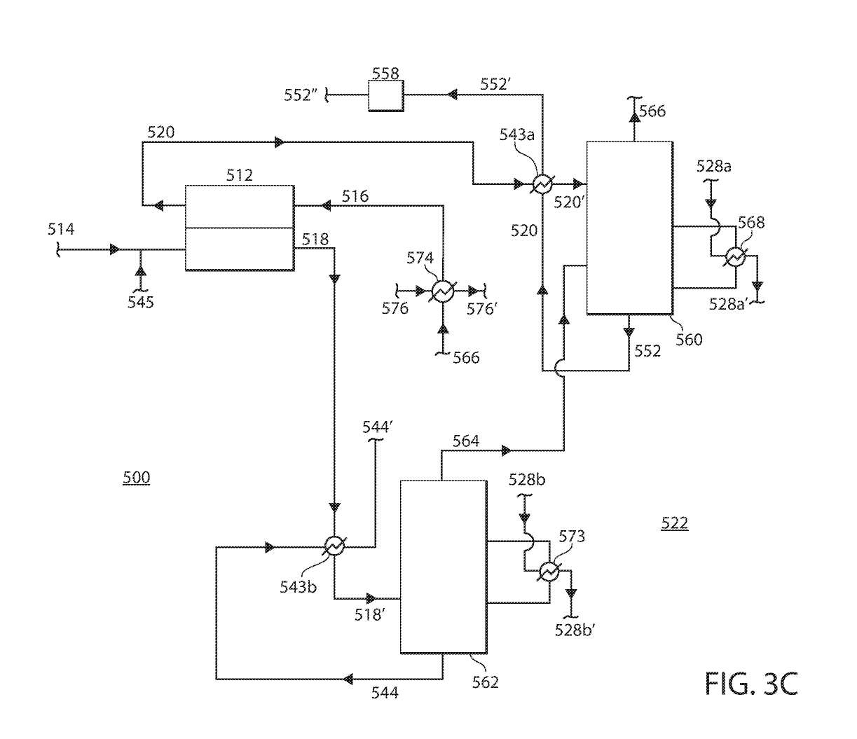

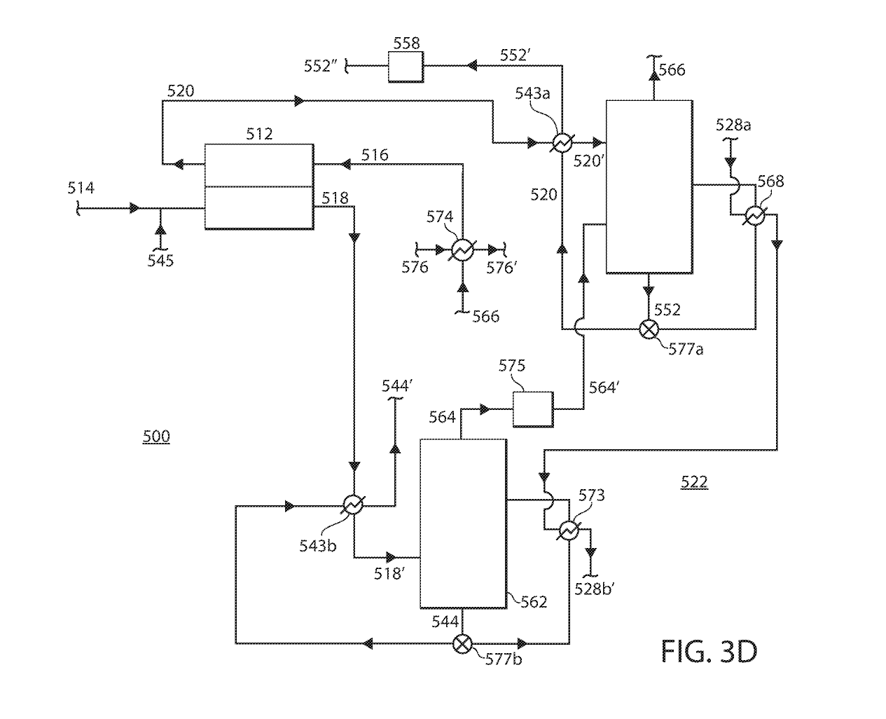

FIG. 3A depicts an osmotically driven membrane system 500 including an alternative arrangement for recovering draw solutes. As shown in FIG. 3, the system 500 includes one or more forward osmosis membrane modules 512 (similar to those described above) in fluid communication with a draw solute recovery/separation system 522. Each forward osmosis module can include one or more forward osmosis membranes 513 at least partially creating first and second chambers 512a, 512b for receiving the various streams. In an embodiment with a plurality of forward osmosis membrane modules 512, the modules can be arranged in series, parallel, or a combination of both. The module(s) 512 is also in fluid communication with a feed source or stream 514 and a concentrated draw solution source or stream 516 and outputs a concentrated feed stream 518 (e.g., brine) and a dilute draw solution 520. All or a portion of the concentrated feed stream 518 and the dilute draw solution 520 are directed to the separation system 522.

Generally, the dilute draw solution 520 is directed to a first separation apparatus 560, such as a thermal recovery device (e.g., a distillation column or membrane distillation apparatus); however, other mechanical separation means (e.g., filtration or chemical manipulation) can be used in combination with or in place of the thermal recovery device. The concentrated feed 518 is directed to a second separation apparatus 562, similar to 560, for further concentration. The two separation apparatus 560, 562 and related componentry (e.g., valves, sensors, controls, plumbing etc.) make up the basic draw solute recovery/separation system 522.

The separation system 522 is similar to that described in FIG. 2, but is modified for alternative thermal integration and direct heat application, for example, via steam or a hot fluid. In some cases, this arrangement may actually have an increased cost associated with the use of direct steam; however, the use of direct steam, as opposed to electricity, can result in an overall energy savings. Generally, earlier designs required a large amount of cooling water at a final condenser for recycling the concentrated draw solution, as the draw solute vapors going to the final condenser are coming from the tops of both separation apparatus 560, 562 in the case of thermal recovery (e.g., distillation columns). In the depicted embodiment, the vapors 564, 566 from the column tops are used to preheat the associated dilute draw solution 520 and brine 518 that are being introduced to the separation apparatus 560, 562, as described in greater detail below.

This arrangement has at least two advantages: As the vapors 564, 566 exchange with pre-heaters 543a, 543b, the draw solution vapors 564, 566 are at least partially condensed, thereby reducing the load on the final condenser 574; which also reduces the overall steam requirements for the separation apparatus 560, 562. For example, at the brine separation apparatus 562, when exchanging with the high energy brine vapor stream 564, the preheating partially vaporizes the brine feed 518′ reducing the load on the apparatus reboiler 573 and reducing steam requirements. The brine 544 being discharged is typically not separately cooled, which is an advantage for further concentrating the brine 544 (e.g., a higher temperature brine is more favorable for a crystallizer process or other ZLD process). With respect to the product water 552 exiting the apparatus 560, this water is typically not cooled, unless there is a specific product water discharge temperature required, thereby providing additional savings. If there is a need for cooling the product water, the savings achieved on the duty of the condenser 574 exceeds any additional cooling requirements for the product water 552 by, for example, a minimum of 20% on the overall cooling load in a particular embodiment. In embodiments where the product water 552 requires cooling or other processing, the product water 552 can be directed to an optional, secondary apparatus/process 558 that can include cooling and/or filtration (e.g., RO polishing) as needed. In the case of RO polishing or similar process, the retentate can be directed back to the feed 518.

Referring back to FIG. 3A, the overall system 500 includes one or more means 545 for introducing an additive (e.g., anti-scalants, acid, catalyst, etc.) to one or more streams (e.g., the feed stream 514) and/or system operations. Typically, the means 545 will include a valve and porting arrangement and may also include any necessary reservoirs, sensors, and/or controls for manual or automatic operation thereof. FIG. 3A also depicts an optional valve 577 for by-passing all or a portion of the dilute draw solution 520 from the membrane module(s) 512. Generally, a portion of the dilute draw solution 520 may by-pass the separation apparatus 560 as necessary to maintain a particular concentration level of draw solutes in the concentrated draw solution 516 being returned to the membrane module(s) 512. Additionally, where the afore-mentioned portion of the dilute draw solution 520 by-passes the preheater 543a, this cooler dilute draw solution 520 may assist in further lowering the cooling load on the final condenser 574. Generally, the cooling fluid 576 provided to the final condenser 574 may be an independent source of cooling water or could be another stream within the system 500 that requires heating. In some embodiments, the feed stream 514 may be used as the cooling fluid to provide preheating to the feed 514, in which case, the exiting cooling fluid 576′ is directed to the membrane module(s) 512 for introduction thereto.

During operation, the preheated dilute draw solution 520′ exiting the preheater 543a is introduced to the separation apparatus 560 while thermal energy (e.g., steam) 528a is introduced to the apparatus 560 via its reboiler 568. The exiting thermal energy (e.g., the condensed steam) 528a′ can be discarded or recycled elsewhere in the system. The volatilized draw solutes (and some solvent) 566 form the tops product of the apparatus 560 and are directed through the preheater 543a to preheat the dilute draw solution 520 and at least partially condense the draw solutes 566′, which in turn are directed to the final condenser 574 before reintroduction to the membrane module(s) 512 as concentrated draw solution 516. In one or more embodiments, the partially condensed draw solutes 566′ are combined with a portion of the dilute draw solution 520 and/or an additive (e.g., make-up draw solutes, anti-scalants, pH adjusters, etc.) as necessary to maintain a desired draw solute concentration and/or draw solution 516 composition. The bottoms product of the apparatus 560 is the previously described product solvent (e.g., water) 552, which may be further processed and output as a final product solvent 552′.

Similarly, the concentrated feed 518 is directed to the second separation apparatus 562 and its associated preheater 543b. The preheated brine 518′ enters the apparatus 562, while thermal energy 528b is introduced to the apparatus 562 via its reboiler 573. The exiting thermal energy 528b′ can be discarded or recycled elsewhere in the system 500. Any draw solutes that reverse fluxed through the membrane(s) will be volatilized, along with additional solvent within the concentrated feed 518′, to form the tops product 564 of the apparatus 562, which is directed through the preheater 543b to preheat the concentrated feed 518 and at least partially condense any draw solutes 564′ contained therein. These draw solutes and solvent are in turn directed to the final condenser 574 before reintroduction to the membrane module(s) 512 as concentrated draw solution 516. In one or more embodiments, the partially condensed draw solutes 564′ are combined with one or more of the partially condensed draw solutes 566′ from separation apparatus 560, a portion of the by-passed dilute draw solution 520, or an additive (e.g., make-up draw solutes). The bottoms product 544 of the apparatus 560 is a further concentrated version of the concentrated feed 518′, which can be discarded or sent for further processing, such as to a crystallizer.

FIG. 3B depicts an alternative embodiment of the system of FIG. 3A. Generally, the system of FIG. 3B is configured to use different streams for preheating the various streams to be processed. This arrangement, as discussed in greater detail below, provides a cooled product water for further processing and reduces the thermal load on the reboilers and final condenser. Generally, this alternative arrangement reduces the utility consumption of both steam and cooling water for the direct heat application for draw solute recovery. As shown in FIG. 3B, the vaporized draw solutes and solvent 564 from the second separation apparatus 562 are directed to the first separation apparatus 560 for use as a source of thermal energy therein to vaporize the draw solutes out of the dilute draw solution 520. These vaporized draw solutes 566 are now directed to the preheater 543b for preheating the concentrated first solution 518 prior to it being introduced to the second separation apparatus 562. The partially condensed draw solutes 566′ are then directed to the final condenser 574, as previously described with respect to FIG. 3A, and then returned to the osmotically driven membrane system 512 for use as the concentrated draw solution 516. The now heated bottoms product 552 (e.g., the product solvent) of the first separation apparatus 560 is directed to preheater 543a to preheat the dilute draw solution 520 prior to it being introduced to the first separation apparatus 560. The cooled product 552′ can be directed to a further process 558 as described above with respect to FIG. 3A and then collected as a final product 552″

FIG. 3C depicts an alternative embodiment of the systems of FIGS. 3A and 3B. Generally, the system 500 is similar to those described with respect to FIGS. 3A and 3B, except the heated brine (i.e., bottoms product) 544 from the second separation apparatus 562 is used to preheat the incoming concentrated feed 518. The cooled brine 544′ can be discarded or sent for further processing as described herein. Tops product (i.e., vaporized draw solutes) 566 of the first separation apparatus 560 can be directed to the final condenser 574 as shown and/or a portion of the product 566 can be used for preheating the dilute draw solution, for example with a second preheater in series with the first preheater 543a or in place of the product 552 as the heating medium.

FIG. 3D depicts yet another alternative embodiment of the systems of FIGS. 3A-3C. Generally, the system 500 is similar to those described with respect to FIGS. 3A-5C, with a portion of the heated brine (i.e., bottoms product) 544 from the second separation apparatus 562 is used to preheat the incoming concentrated feed 518 and a portion recirculated within the second separation apparatus 562. The apportionment of the heated brine 544 can be accomplished with a metering/multi-directional valve as necessary. The cooled brine 544′ can be discarded or sent for further processing as described herein. As shown in FIG. 3D, the tops product (i.e., vaporized draw solutes) 564 of the second separation apparatus 562 are directed to a compressor 575 to create a vacuum on the second separation apparatus 562 and lower the temperature for vaporizing the solutes out of the brine 518. The compressed vapors 564′ are directed to the first separation apparatus 560 as previously described with respect to other embodiments of the separation system 522. The first separation apparatus 560 generally operates as previously described, with the tops product (i.e., vaporized draw solutes) 566 being directed to the final condenser 574 as shown and/or a portion of the product 566 can be used for preheating the dilute draw solution. The heated bottoms product (i.e., product water) 552 can also be apportioned with one portion being used for preheating the dilute draw solution 520 and another portion being recirculated through the apparatus 560 via a metering valve 577a. In one embodiment, the thermal energy 528a used for heating the first separation apparatus is direct steam with the condensate (i.e., only partially condensed steam) being directed to the reboiler 573 of the second separation apparatus 562.

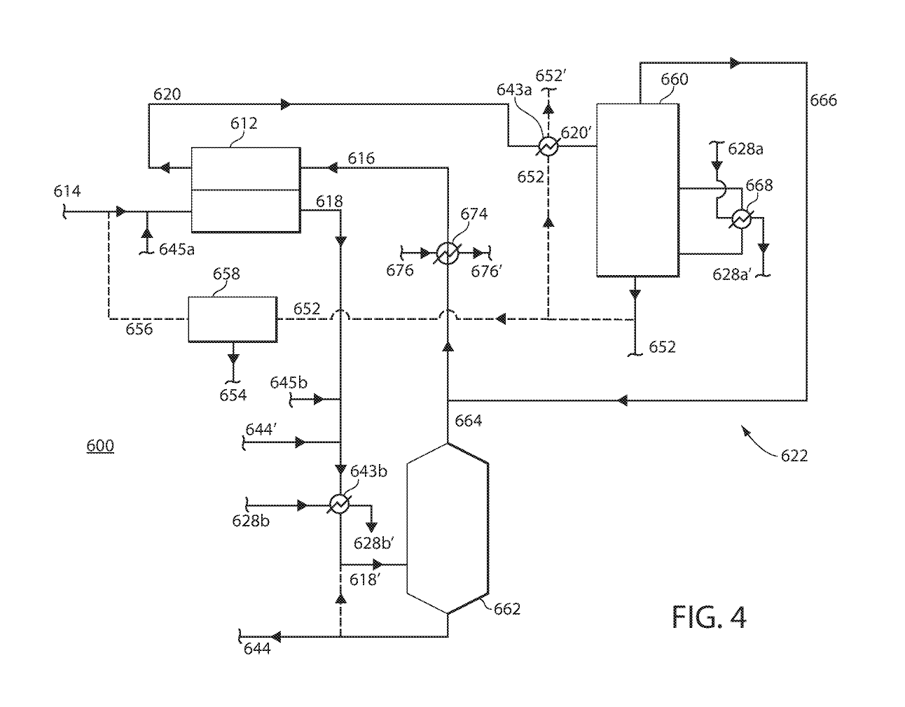

FIG. 4 depicts an alternative osmotically driven membrane system 600 configured for enhancing brine concentration in addition to recovering draw solutes. As shown in FIG. 4, the system 600 includes one or more forward osmosis membrane modules 612 (similar to those described above) in fluid communication with a draw solute recovery/separation system 622. In an embodiment with a plurality of forward osmosis membrane modules 612, the modules can be arranged in series, parallel, or a combination of both. The module(s) 612 is also in fluid communication with a feed source or stream 614 and a concentrated draw solution source or stream 616 and outputs a concentrated feed stream 618 (e.g., brine) and a dilute draw solution 620. The draw solute recovery system 622 generally includes one or more separation apparatus in fluid communication with the concentrated feed stream 618 and the dilute draw solution 620 and further includes any necessary valves, heat exchangers, sensors, controls, plumbing, etc.

Generally, the dilute draw solution 620 is directed to a first separation apparatus 660, such as a thermal recovery device (e.g., one or more distillation columns and/or membrane distillation apparatus). In some embodiments, mechanical separation means (e.g., filtration or chemical manipulation) can be used in place of or in addition to the thermal recovery device. The concentrated feed 618 is directed to a second separation apparatus 662, such as a crystallizer or other thermal separation device for further concentration. In addition, the system 600 can include one or more means 645 for introducing an additive (e.g., anti-scalants, acid, catalyst, seeds, etc.) to one or more streams (e.g., the feed stream 614) and/or system operations. Similar to those described above, the means 645 can include a valve and porting arrangement and any necessary reservoirs, sensors, and/or controls for manual or automatic operation thereof.

As shown in FIG. 4, the first separation apparatus 660 receives the dilute draw solution 620 and includes a reboiler 668, as commonly known in the art, configured for receiving a source of thermal energy 628a (e.g., steam) and outputting a depleted thermal energy stream 628a′ (e.g., condensed steam) that can be discarded or otherwise recycled within the system 600 (e.g., added to the feed stream 614 for purification or used for additional heating). As also shown, the dilute draw solution 620 passes through a first preheater 643a before entering the first separation apparatus 660, which outputs a tops product (typically vaporized draw solutes and a portion of solvent) 666 that can be recycled as re-concentrated draw solution 616 (described below) and a bottoms product (typically heated solvent) 652. In some cases, the bottoms product 652 can be recovered as the product solvent or sent for further processing (described below). In one or more embodiments, all or a portion of the product solvent 652 can be used to preheat the incoming dilute draw solution 620 via the preheater 643a. The cooled product solvent 652′ can be used as is, discarded, or sent for further processing. For example, all or a portion of the product solvent 652, 652′ can be directed to an additional system/process 658, such as filtration (e.g., reverse osmosis or nanofiltration) or additional thermal separation. In one or more embodiments, the additional system 658 is a polishing RO unit that produces a more purified product solvent 654 and a retentate 656 that can be recycled to the feed stream 618 for further processing. In some embodiments, the tops product 666 can be used for preheating the dilute draw solution 620, similar to what is described with respect to FIG. 3A.

As shown in FIG. 4, all or a portion of the concentrated feed 618 can be directed to the crystallizer (e.g., a forced circulation crystallizer) 662. Typically, the concentrated feed 618 is going to include a brine having a concentration of about 75,000 to 300,000 total dissolved solids (TDS), preferably about 200,000 TDS or greater. Generally, the greater the concentration, the more efficient the brine concentration process. Typical osmotically driven membrane systems cannot produce a concentrated feed high enough and will require additional thermal separation/concentration process to be performed on the concentrated feed before it can be sent to a crystallizer or other ZLD process. The second separation apparatus operating on a more concentrated brine eliminates the need for additional equipment to bring the concentrated output of the osmotically driven membrane system to saturation, while also recovering additional draw solutes.

Generally, the concentrated feed 618 passes through a second preheater 643b prior to entering the second separation apparatus 662, in this case one or more crystallizers. Similar to that described above, the second preheater 643b receives a source of thermal energy 628b and outputs a depleted thermal energy source 628b′ that can be discarded or recycled within the system 600. Typically, certain draw solutes will have reverse fluxed through the membrane module 612 and will be contained within the concentrated feed 618. These draw solutes and additional solvent (collectively product 664) are vaporized within the crystallizer 662 and outputted therefrom, where they can be combined with the product 666 from the first separation apparatus 660 and recovered.

The combined products 664, 666 are directed to a final condenser 674 to fully absorb the draw solutes into the concentrated draw solution 616 and lower the temperature of the re-concentrated draw solution 616 as necessary for reintroduction into the membrane module(s) 612. Generally, the cooling fluid 676 provided to the final condenser 674 may be an independent source of cooling water or could be another stream within the system 600 that requires heating, such as the feed stream 614. Where the feed stream 614 is preheated via the condenser 674, the exiting cooling fluid (i.e., preheated feed stream) 676′ will be directed back to the membrane module(s) 612 for introduction thereto.

The crystallizer 662 also outputs a further concentrated brine slurry 644 that can be discarded or sent for further processing. Typically, the brine 644 is directed to additional dewatering equipment (not shown), such as that described in PCT Publication No. WO2015/157031, the entire disclosure of which is hereby incorporated by reference herein. In one or more embodiments, the brine 644 is sent to a filter press or centrifuge with the resulting mother liquor 644′ being directed back to the crystallizer 662 for further processing. In some embodiments, all or a portion of the brine slurry 644 can be recirculated back into the crystallizer 662 (e.g., small portion of the slurry 644 is recirculated while a larger portion is directed to the filter press or centrifuge). In some embodiments, the crystallizer circuit also includes introduction means 645b for introducing seeds or other additives to the concentrated feed 618 and/or brine 644′ being directed to the crystallizer 662 to, for example, promote crystallization.

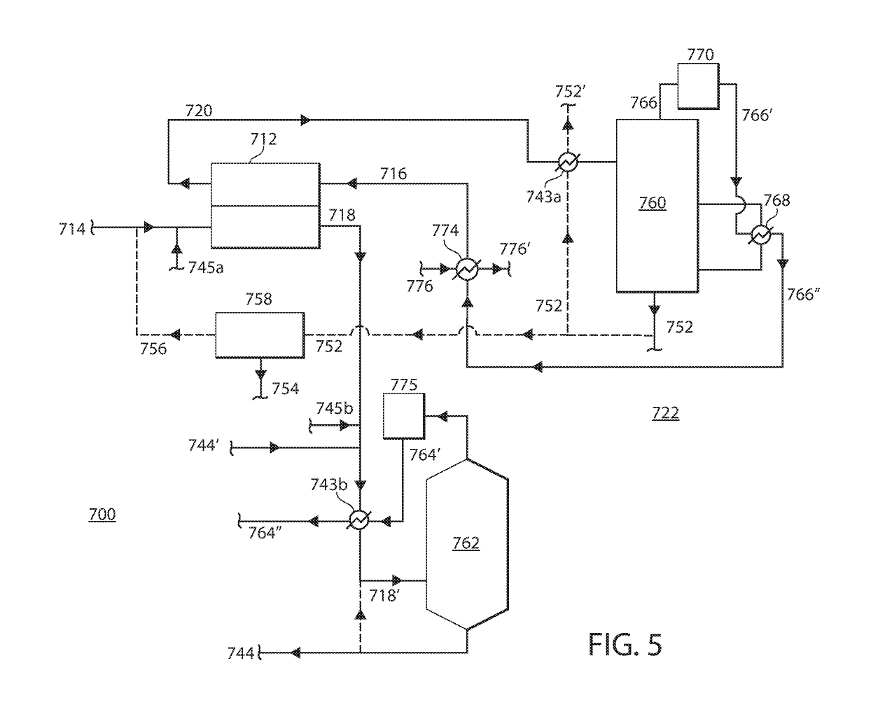

FIG. 4 depicted a draw solute recovery and brine concentration system/process 622 using direct steam introduction. The system 700 depicted in FIG. 5 is similar to the system 600 of FIG. 4, but incorporates mechanical vapor recompression similar to that described above with respect to FIG. 2, which also includes the use of boiler start-up steam similar to that shown in FIG. 2. As shown in FIG. 5, the system 700 includes one or more forward osmosis membrane modules 712 in fluid communication with a draw solute recovery/separation system 722 that includes first and second separation apparatus 760, 762 similar to those described above. The membrane modules 712 are also in fluid communication with a feed source or stream 714 and a concentrated draw solution source or stream 716 and output a concentrated feed stream 718 and a dilute draw solution 720, where the dilute draw solution 720 and the concentrated feed stream 718 are introduced to the first and second separation apparatus 760, 762 as described above with respect to FIG. 4.

As shown in FIG. 5, the separation apparatus 760, 762 of the draw solute recovery system 722 each include one or more compressors 770, 775, respectively, for recovering and reusing the heat of the thermal energy introduced to the respective apparatus 760, 762. The vapor 766 exiting the first separation apparatus 760 is directed to the compressor(s) 770, with the compressed vapors 766′ exiting the compressor 770 and being directed to the reboiler 768 to reduce the overall thermal energy requirement of the first separation apparatus 760. As described with respect to FIG. 2, by compressing the vapor 766, the vapor condensing temperature is raised to a temperature higher than the reboiler 768 such that the latent heat of the compressed vapor 766′ can be used as the thermal energy supply to the separation apparatus 760. The number and capacity of the compressor(s) will be selected to suit a particular application (e.g., the required differential temperature at the reboiler, the separation apparatus operating pressure, the compressor's compression ratio, flow rate, and ambient conditions). The partially condensed vapor 766″ leaving the reboiler 768 can be directed to a final condenser 774, similar to that described with respect to FIG. 4.

Further, the vapor 764 exiting the crystallizer/second separation apparatus 762 is also directed to one or more compressors 775, with the compressed vapors 764′ exiting the compressor(s) 775 and being directed to the second preheater 743b to reduce the overall thermal energy requirement of the second separation apparatus 762. As described above, the increased vapor condensing temperature allows the latent heat of the compressed vapor 764′ to be used as the thermal energy supply to the separation apparatus 762. The number and capacity of the compressor(s) for the second separation apparatus 762 will also be selected to suit a particular application. The partially condensed vapor 764″ leaving the preheater 743b can be discarded or combined with vapor 766″ and directed to the final condenser 774, similar to that described with respect to FIG. 4. The rest of the system 700 operates similar to that described with respect to FIG. 4.

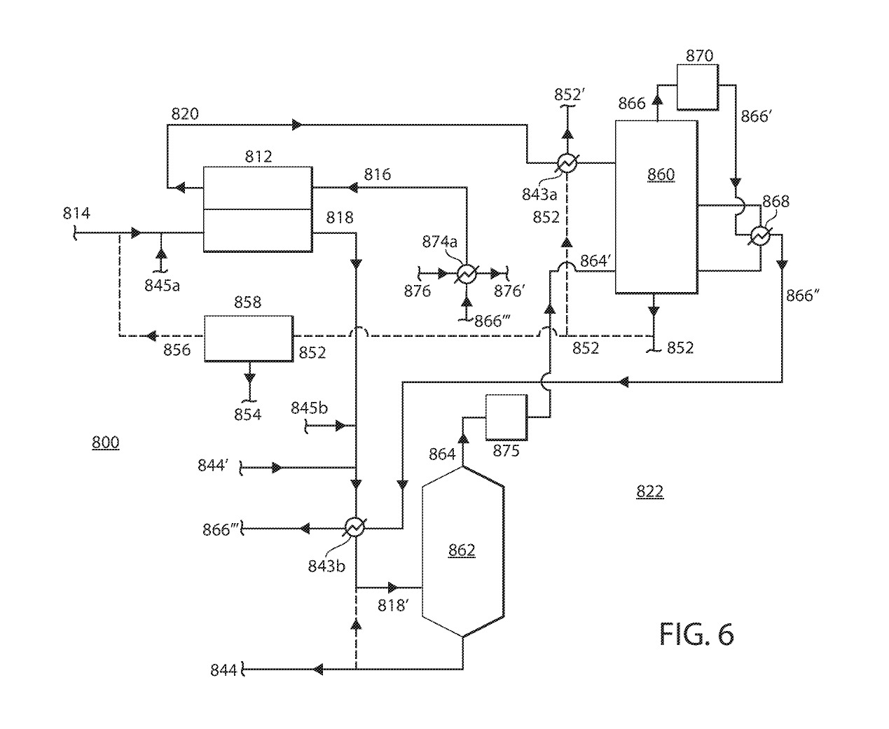

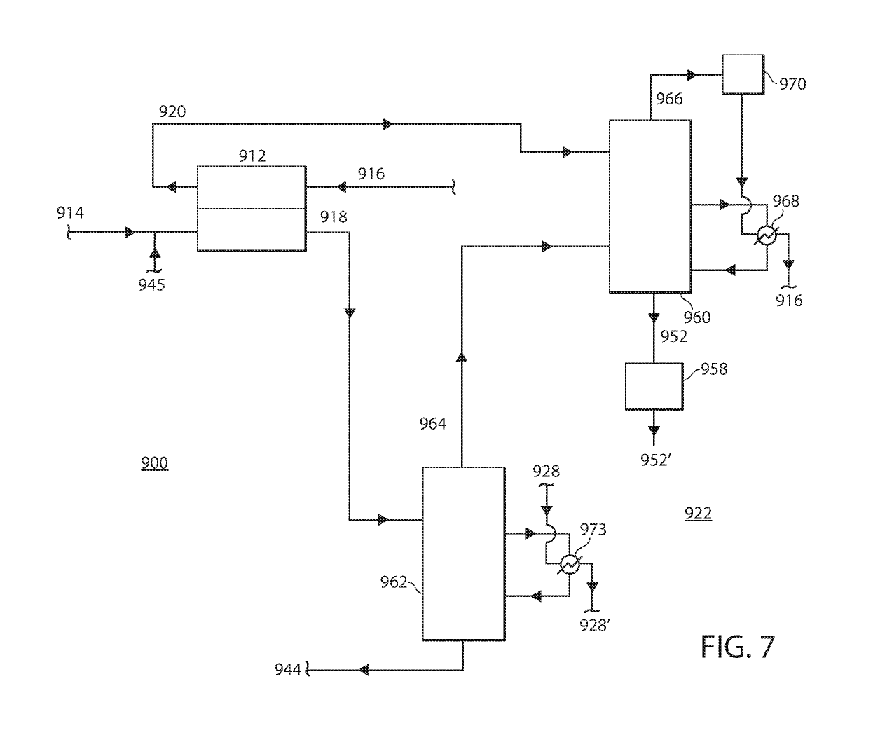

FIG. 6 depicts an alternative system 800 to the system 700 of FIG. 5, but with an integrated mechanical vapor recompression subsystem, as opposed to the two separate subsystems depicted in FIG. 5. Generally, the system 800 and various components are the same as those described with respect to FIGS. 6 and 7, except as follows. As shown in FIG. 6, the heated vapor 864 exiting the second separation apparatus 862 (also a crystallizer in this embodiment) is directed to one or more compressors 875 and then to the first separation apparatus 860 as its thermal energy input. Similar to that described above, the tops product 866 of the first separation apparatus 860 is directed to one or more compressors 870 and then directed to the first separation apparatus' reboiler 868, further reducing the overall thermal energy requirement of the first separation apparatus 860.

In contrast to the system 700 of FIG. 5, the partially condensed vapor 866″ is not directed to the final condenser 874, but instead first directed to the second preheater 843b to preheat the concentrated feed 818 directed to the second separation apparatus 862. The further condensed vapor 866′″ is then directed to the final condenser 874 for completing the recovery and recycling of the concentrated draw solution 816. The rest of the system 800 operates similar to that described with respect to FIGS. 4 and 5.

In some of the previously described embodiments, the draw solute recovery process, and in some cases the additional brine concentration process, is supplied with thermal energy via either direct steam or through the use of MVC. In some cases, the use of MVC has a high capital cost (CapEx) and process complexity associated, at least in part, to the need for large and/or multiple compressors and multiple points of partial condensation in the system. Additionally, the second separation apparatus (typically the distillation apparatus for further brine concentration) is required to run under vacuum to utilize any partially condensed draw solute vapor stream to power the reboiler. A direct steam system tends to have lower capital cost and be a simpler process; however, direct steam has a high operation cost (OpEx). For example, in some facilities (e.g., the power sector), process steam is nearly twice as expensive as electricity and in those cases the latent heat of the draw solute vapors is not integrated back into the system. Another advantage of steam over MVC is that when concentrating the brine from the osmotically driven membrane system in the brine concentration apparatus (i.e., second separation apparatus), the use of steam eliminates the need to go to the high compression ratios necessary in MVC systems to overcome any boiling point elevation issues in the brine concentration apparatus, which can be more expensive and complex, and in some cases it is just not possible to achieve the necessary boiling points. As such, there is a need for a hybrid system that utilizes both direct process steam and electricity/MVC to minimize overall CapEx and OpEx expenses for recovering draw solutes and concentrating the brine output from the osmotically driven membrane system, while providing flexibility in utilizing the best available resources.

FIG. 7 depicts an example of the afore-mentioned hybrid system 900 discussed above, with or without the use of preheating. Generally, the system 900 for recovering draw solutes and further concentrating the brine can be a hybrid approach incorporating any of the various features of the foregoing systems described herein. In various embodiments, the second separation apparatus 962 is operated using direct steam for the thermal energy input 928, while utilizing MVC and the tops vapors from the second apparatus 962 as the thermal energy for the first separation apparatus 960. This arrangement of combining process steam and electricity to separate the various streams results in about half of the energy used and a reduction in CapEx where a single compressor can be used. This arrangement also lowers the discharge pressure required on the compressor(s), which gives greater flexibility in the selection of compressors.

More specifically, the system 900 as shown in FIG. 7 includes an osmotically driven membrane system 912, similar to those previously described, in fluid communication with a source of feed solution 914 and concentrated draw solution 916 and configured for receiving same. The osmotically driven membrane system 912 is also in fluid communication with a draw solute recovery system 922 that includes two or more separation apparatus 960, 962 configured for receiving a dilute draw solution 920 and a concentrated feed solution 918 outputted from the membrane system 912.

As shown, all or at least a portion of the concentrated feed solution 918 is directed to the second separation apparatus 962, similar to those previously described, while a source of thermal energy 928 is directed to a heat transfer means 973 (e.g., reboiler) associated with the second separation apparatus 962. The thermal energy 928 heats the concentrated first solution within the second separation apparatus causing draw solute vapors and solvent within the solution 918 to vaporize. Direct steam is used as the thermal energy 928 for the second separation apparatus 962 with vaporized draw solutes and solvent 964 exiting the apparatus 962 then entering the first separation apparatus 960 at a specified stage

As further shown in FIG. 7, at least a portion of the dilute draw solution 920 is directed to the first separation apparatus 960 along with the vaporized draw solutes and solvent 964 that are used to supplement the thermal requirements of the first separation apparatus reboiler 968. The thermal energy introduced to the first separation apparatus 960 vaporizes the draw solutes within the apparatus. The draw solute vapors 966 exiting the first separation apparatus 960 are directed to one or more compressors 970, where they are mechanically compressed and then directed to the reboiler 968 to provide additional thermal energy to the first separation apparatus 960. The vapors that condense within the reboiler are essentially re-concentrated draw solution 916 that can be directed back to the osmotically driven membrane system 912 or further processed (e.g., additional condensing and/or concentration) before being used as the concentrated draw solution 916.

In accordance with one or more embodiments, the devices, systems and methods described herein may generally include a controller for adjusting or regulating at least one operating parameter of the device or a component of the systems, such as, but not limited to, actuating valves and pumps, as well as adjusting a property or characteristic of one or more fluid flow streams through an osmotically driven membrane module, or other module in a particular system. A controller may be in electronic communication with at least one sensor configured to detect at least one operational parameter of the system, such as a concentration, flow rate, pH level, or temperature. The controller may be generally configured to generate a control signal to adjust one or more operational parameters in response to a signal generated by a sensor. For example, the controller can be configured to receive a representation of a condition, property, or state of any stream, component, or subsystem of the osmotically driven membrane systems and associated pre- and post-treatment systems. The controller typically includes an algorithm that facilitates generation of at least one output signal that is typically based on one or more of any of the representation and a target or desired value, such as a set point. In accordance with one or more particular aspects, the controller can be configured to receive a representation of any measured property of any stream, and generate a control, drive or output signal to any of the system components, to reduce any deviation of the measured property from a target value.

In accordance with one or more embodiments, process control systems and methods may monitor various concentration levels, such as may be based on detected parameters including pH and conductivity. Process stream flow rates and tank levels may also be controlled. Temperature and pressure may be monitored. Membrane leaks may be detected using ion selective probes, pH meters, tank levels, and stream flow rates. Leaks may also be detected by pressurizing a draw solution side of a membrane with gas and using ultrasonic detectors and/or visual observation of leaks at a feed water side. Other operational parameters and maintenance issues may be monitored. Various process efficiencies may be monitored, such as by measuring product water flow rate and quality, heat flow and electrical energy consumption. Cleaning protocols for biological fouling mitigation may be controlled such as by measuring flux decline as determined by flow rates of feed and draw solutions at specific points in a membrane system. A sensor on a brine stream may indicate when treatment is needed, such as with distillation, ion exchange, breakpoint chlorination or like protocols. This may be done with pH, ion selective probes, Fourier Transform Infrared Spectrometry (FTIR), or other means of sensing draw solute concentrations. A draw solution condition may be monitored and tracked for makeup addition and/or replacement of solutes. Likewise, product water quality may be monitored by conventional means or with a probe such as an ammonium or ammonia probe. FTIR may be implemented to detect species present providing information which may be useful to, for example, ensure proper plant operation, and for identifying behavior such as membrane ion exchange effects.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is, therefore, to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

What is claimed is:

1. A system for concentrating a feed stream and recovering draw solution solutes from an osmotically driven membrane system, the system comprising:
a forward osmosis unit comprising at least one membrane having a first side and a second side, the first side of the at least one membrane fluidly coupled to a source of a first solution and the second side of the at least one membrane fluidly coupled to a source of a concentrated draw solution, wherein the at least one membrane is configured for osmotically separating a solvent from the first solution, thereby forming a more concentrated first solution on the first side of the at least one membrane and a dilute draw solution on the second side of the at least one membrane; and
a separation system in fluid communication with the forward osmosis unit and configured for receiving the concentrated first solution and the dilute draw solution from the forward osmosis unit, the separation system comprising:
a first separation apparatus in fluid communication with the osmotically driven membrane system and comprising:
a first thermal recovery device;
a first heat transfer means in fluid communication with the forward osmosis unit for receiving the dilute draw solution and coupled to a first inlet of the first thermal recovery device for preheating and introducing the dilute draw solution into the first thermal recovery device;
a second heat transfer means coupled to the first thermal recovery device and having an inlet coupled to a first source of thermal energy and an outlet coupled to the first thermal recovery device for directing thermal energy to the first thermal recovery device to cause solutes within the dilute draw solution in the first thermal recovery device to vaporize;
a first outlet for removing the vaporized dilute draw solution solutes from the first thermal recovery device, wherein the first outlet is in fluid communication with the first heat transfer means for providing the vaporized draw solution solutes as a source of thermal energy thereto for preheating the dilute draw solution; and
a second outlet for removing a bottoms product from the first thermal recovery device; and
a second separation apparatus in fluid communication with the osmotically driven membrane system and comprising:
a second thermal recovery device;
a first heat transfer means in fluid communication with the forward osmosis unit for receiving the concentrated first solution and coupled to a first inlet of the second thermal recovery device for preheating and introducing the concentrated first solution into the second thermal recovery device;
a second heat transfer means coupled to the second thermal recovery device and having an inlet coupled to a second source of thermal energy and an outlet coupled to the second thermal recovery device for directing thermal energy to the second thermal recovery device to cause solutes within the concentrated first solution in the second thermal recovery device to vaporize;
a first outlet for removing the vaporized solutes from the second thermal recovery device, wherein the first outlet is in fluid communication with the first heat transfer means for providing the vaporized solutes as a source of thermal energy thereto for preheating the concentrated first solution; and
a second outlet for removing a bottoms product from the second thermal recovery device.

2. A system for concentrating a feed stream and recovering draw solution solutes from an osmotically driven membrane system, the system comprising:
a forward osmosis unit comprising at least one membrane having a first side and a second side, the first side of the at least one membrane fluidly coupled to a source of a first solution and the second side of the at least one membrane fluidly coupled to a source of a concentrated draw solution, wherein the at least one membrane is configured for osmotically separating a solvent from the first solution, thereby forming a more concentrated first solution on the first side of the at least one membrane and a dilute draw solution on the second side of the at least one membrane; and
a separation system in fluid communication with the forward osmosis unit and configured for receiving the concentrated first solution and the dilute draw solution from the forward osmosis unit, the separation system comprising:
a first separation apparatus in fluid communication with the osmotically driven membrane system and comprising:
a first thermal recovery device;
a first heat transfer means in fluid communication with the forward osmosis unit for receiving the dilute draw solution and a first source of thermal energy for preheating the dilute draw solution, the first heat transfer means coupled to a first inlet of the first thermal recovery device for introducing the preheated dilute draw solution into the first thermal recovery device;
a second heat transfer means coupled to the first thermal recovery device and having an inlet coupled to a second source of thermal energy and an outlet coupled to the first thermal recovery device for directing the second source of thermal energy to the first thermal recovery device to cause solutes within the dilute draw solution in the first thermal recovery device to vaporize;
a first outlet for removing the vaporized dilute draw solution solutes from the first thermal recovery device; and
a second outlet for removing a bottoms product from the first thermal recovery device, wherein the second outlet is in fluid communication with the first heat transfer means for providing the bottoms product as the first source of thermal energy thereto for preheating the dilute draw solution; and
a second separation apparatus in fluid communication with the osmotically driven membrane system and comprising:
a second thermal recovery device;
a heat transfer means in fluid communication with the forward osmosis unit for receiving the concentrated first solution and a source of thermal energy for heating the concentrated first solution, the heat transfer means coupled to a first inlet of the second thermal recovery device for introducing the heated concentrated first solution into the second thermal recovery device, where solutes within the concentrated first solution in the second thermal recovery device are vaporized;
a first outlet for removing the vaporized solutes from the second thermal recovery device; and
a second outlet for removing a concentrated brine from the second thermal recovery device.

3. The system of claim 1 or 2, wherein the first thermal recovery device is a distillation apparatus.

4. The system of claim 1 or 2, wherein the second thermal recovery device is a crystallizer.

5. The system of claim 2 further comprising one or more compressors in fluid communication with the first outlet of the first thermal recovery device and at least one of the first or second heat transfer means of the first separation apparatus.

6. The system of claim 2 further comprising one or more compressors in fluid communication with the first outlet of the second thermal recovery device and the heat transfer means of the second separation apparatus for providing at least a portion of the source of thermal energy thereto.

7. The system of claim 1 or 2 further comprising at least one condenser having an inlet in fluid communication with at least one of the first outlet of the first thermal recovery device or the first outlet of the second thermal recovery device for receiving the tops product of the first and/or second thermal recovery device and an outlet in fluid communication with the forward osmosis unit for providing the concentrated draw solution thereto.

8. A method of enhancing brine concentration and recovering draw solutes from an osmotically driven membrane system, the method comprising the steps of:
providing a source of dilute draw solution from the osmotically driven membrane system, wherein the dilute draw solution comprises thermally removable draw solutes;
providing a source of a concentrated feed solution from the osmotically driven membrane system, wherein the concentrated feed comprises a brine and thermally removable draw solutes that reverse fluxed through the membrane system;
introducing at least a portion of the dilute draw solution to a first separation system;
introducing a source of first source thermal energy to the first separation system;
vaporizing dilute draw solution solutes out of the dilute draw solution;
recovering the vaporized dilute draw solution solutes from the first separation system;
recycling the draw solution solutes from the first separation system to the osmotically driven membrane system;
introducing at least a portion of the concentrated feed solution to a second separation system;
introducing a second source of thermal energy to the second separation system;
vaporizing draw solutes and solvent out of the concentrated feed solution;
recovering the vaporized draw solutes and solvent from the second separation system and discharging a further concentrated feed solution therefrom; and
recycling the draw solutes and solvent from the second separation system to the osmotically driven membrane system.

9. The method of claim 8 further comprising directing the further concentrated feed solution to at least one of a filter press or a centrifuge.

10. The method of claim 9 further comprising the step of reintroducing the further concentrated feed solution from the at least one of a filter press or a centrifuge to the second separation apparatus.

11. The method of claim 8, wherein the step of vaporizing the dilute draw solution solutes out of the first separation system comprises exposing the dilute draw solution to the first source of thermal energy via a distillation apparatus.

12. The method of claim 8, wherein the step of vaporizing the draw solutes and solvent out of the second separation system comprises exposing the concentrated feed solution to the second source of thermal energy via a crystallizer.

13. The system of claim 2, wherein the first outlet of the second thermal recovery device is in fluid communication with the first thermal recovery device for providing an additional source of thermal energy to the first thermal recovery device.

14. The system of claim 13 further comprising a compressor in fluid communication with the first outlet of the second thermal recovery device and the first thermal recovery device.

15. The system of claim 2, wherein the second thermal recovery device is a distillation apparatus.

16. The system of claim 2, wherein the second separation apparatus comprises a second heat transfer means coupled to the second thermal recovery device and having an inlet coupled to a second source of thermal energy and an outlet coupled to the second thermal recovery device for directing the second source of thermal energy to the second thermal recovery device to vaporize the draw solutes within the concentrated first solution in the second thermal recovery device.
